(19) United States
(12) Patent Application Publication
(10) Pub. No.: US 2024/0282024 A1
(43) Pub. Date: Aug. 22, 2024

(54) TRAINING METHOD, METHOD OF DISPLAYING TRANSLATION, ELECTRONIC DEVICE AND STORAGE MEDIUM

(71) Applicant: Beijing Baidu Netcom Science Technology Co., Ltd., Beijing (CN)

(72) Inventors: Liang WU, Beijing (CN); Shanshan LIU, Beijing (CN); Chengquan ZHANG, Beijing (CN); Kun YAO, Beijing (CN)

(21) Appl. No.: 18/041,206

(22) PCT Filed: Apr. 22, 2022
(86) PCT No.: PCT/CN2022/088395

§ 371 Date: Feb. 9, 2023

(30) Foreign Application Priority Data
Aug. 17, 2021 (CN) 202110945871.0

(51) Int. Cl. G06T 11/60; G06F 40/58; G06N 3/094; G06T 3/02; G06V 10/774

(52) U.S. Cl. CPC G06T 11/60; G06F 40/58; G06N 3/094; G06T 3/02; G06V 10/774

(57) ABSTRACT

A method of training a text erasure model, a method of display a translation, an electronic device, and a storage medium. The training method includes: processing a set of original text block images by using a generator of a generative adversarial network model to obtain a set of simulated text block-erased images; alternately training the generator and a discriminator of the generative adversarial network model by using a set of real text block-erased images and the set of simulated text block-erased images, so as to obtain a trained generator and a trained discriminator; and determining the trained generator as the text erasure model, wherein a pixel value of a text-erased region in a real text block-erased image contained in the set of real text block-erased images is determined based on a pixel value of another region in the real text block-erased image other than the text-erased region.

This application is a Section 371 National Stage Application of international Application No. PCT/CN2022/088395, filed on Apr. 22, 2022, entitled “TRAINING METHOD AND APPARATUS. METHOD AND APPARATUS OF DISPLAYING TRANSLATION, ELECTRONIC DEVICE AND STORAGE MEDIUM”, which claims priority to Chinese Patent Application No. 202110945871.0 filed on Aug. 17, 2021, which are incorporated herein by reference in their entireties.

### TECHNICAL FIELD

The present disclosure relates to a field of an artificial intelligence technology, in particular to fields of computer vision and deep learning technologies, and may be applied to OCR optical character recognition and other scenarios. Specifically, the present disclosure relates to a training method, a method of display a translation, an electronic device, and a storage medium.

### BACKGROUND

With an advancement of globalization, exchanges between countries in academics, business, life and so on have become increasingly frequent, but there are differences in languages between countries. A text in one language may be translated into a text in another language by a user through a translation application to facilitate communication.

A photo translation is a new form of translation product. In a current photo translation function, an input is an image containing a text in a source language, and an output is an image containing a text in a target translation language.

### SUMMARY

The present disclosure provides a training method, a method of display a translation, an electronic device, and a storage medium.

According to an aspect of the present disclosure, a method of training a text erasure model is provided, including: processing a set of original text block images by using a generator of a generative adversarial network model, so as to obtain a set of simulated text block-erased images, where the generative adversarial network model includes the generator and a discriminator; alternately training the generator and the discriminator by using a set of real text block-erased images and the set of simulated text block-erased images, so as to obtain a trained generator and a trained discriminator; and determining the trained generator as the text erasure model, where a pixel value of a text-erased region in a real text block-erased image contained in the set of real text block-erased images is determined based on a pixel value of another region in the real text block-erased image other than the text-erased region.

According to another aspect of the present disclosure, a method of displaying a translation is provided, including: processing a target original text block image by using a text erasure model, so as to obtain a target text block-erased image, where the target original text block image contains a target original text block; determining a translation display parameter; superimposing a translation text block corresponding to the target original text block on the target text-erased image according to the translation display parameter, so as to obtain a target translation text block image; and displaying the target translation text block image; where the text erasure model is trained using the method described above.

According to another aspect of the present disclosure, an electronic device is provided, including: at least one processor; and a memory communicatively connected to the at least one processor, the memory stores instructions executable by the at least one processor, and the instructions, when executed by the at least one processor, cause the at least one processor to implement the methods described above.

According to another aspect of the present disclosure, a non-transitory computer-readable storage medium having computer instructions therein is provided, and the computer instructions are configured to cause a computer to implement the methods described above.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF TIME DRAWINGS

The accompanying drawings are used for better understanding of the solution and do not constitute a limitation to the present disclosure, in which:

FIG. 1 schematically shows an exemplary system architecture to which a method and an apparatus of training a text erasure model and a method and an apparatus of displaying a translation may be applied according to embodiments of the present disclosure;

FIG. 2 schematically shows a flowchart of a method of training a text erasure model according to embodiments of the present disclosure;

FIG. 3 schematically shows a flowchart of training a discriminator by using a first set of real text block-erased images and a first set of simulated text block-erased images according to embodiments of the present disclosure;

FIG. 4 schematically shows a schematic diagram of a training process of a text erasure model according to embodiments of the present disclosure;

FIG. 5 schematically shows a flowchart of a method of displaying a translation according to embodiments of the present disclosure;

FIG. 6 schematically shows a flowchart of determining a number of translation display lines and/or a translation display height according to embodiments of the present disclosure;

FIG. 7 schematically shows a schematic diagram of a translation display process according to embodiments of the present disclosure;

FIG. 8A schematically shows a schematic diagram of a text erasure process according to embodiments of the present disclosure;

FIG. 8B schematically shows a schematic diagram of a translation pasting process according to embodiments of the present disclosure;

FIG. 9 schematically shows a block diagram of an apparatus of training a text erasure model according to embodiments of the present disclosure;

FIG. 10) schematically shows a block diagram of an apparatus of displaying a translation according to embodiments of the present disclosure; and

FIG. 11 schematically shows a block diagram of an electronic device suitable for implementing a method of training a text erasure model or a method of displaying a translation according to embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those of ordinary skilled in the art should realize that various changes and modifications may be made to embodiments described herein without departing from the scope and spirit of the present disclosure. Likewise, for clarity and conciseness, descriptions of well-known functions and structures are omitted in the following description.

A photo-translation technology may include: taking a picture of a scene containing a text to obtain an image, and then recognizing a text content of a text line in the obtained image; performing a machine translation on the text content to obtain a translated text content; and displaying the translated text content to a user. If it is required to directly display a translation result on an original text line of the image, it is needed to erase a text in the original text line in the image, and then paste a translation to a position of the original text line to display the translation result.

In a process of implementing concepts of the present disclosure, the following technical solution is found. When erasing the text in the original image, a fuzzy filtering may be performed directly on a text region in the original image, or an average color value of a text block region may be used to fill an entire region, so as to enable a user to visually experience the effect of erasing the original text. However, it is easy to cause the text region to be clearly distinguished from other background parts of the image, which results in a poor erasing effect and affects a user's visual experience.

In view of this, embodiments of the present disclosure provide a method and an apparatus of training a text erasure model, a method and an apparatus of displaying a translation, an electronic device, a non-transitory computer-readable storage medium storing computer instructions, and a computer program product. The method of training the text erasure model includes the following steps. A training set is processed using a generator of a generative adversarial network model, so as to obtain a set of simulated text block-erased images. The generative adversarial network model includes the generator and a discriminator. The generator and the discriminator are alternately trained using a set of real text block-erased images and the set of simulated text block-erased images, so as to obtain a trained generator and a trained discriminator. The trained generator is determined as the text erasure model. A pixel value of a text-erased region in a real text block-erased image contained in the set of real text block-erased images is determined based on a pixel value of another region in the real text block-erased image other than the text-erased region.

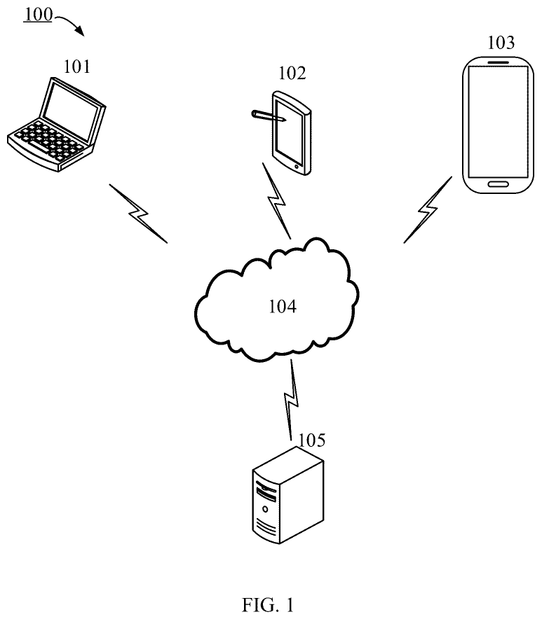

FIG. 1 schematically shows an exemplary system architecture to which a method and an apparatus of training a text erasure model and a method and an apparatus of displaying a translation may be applied according to embodiments of the present disclosure.

It should be noted that FIG. 1 merely shows an example of a system architecture to which embodiments of the present disclosure may be applied to help those skilled in the art understand the technical contents of the present disclosure, but it does not mean that embodiments of the present disclosure may not be applied to other devices, systems, environments or scenarios. For example, in other embodiments, an exemplary system architecture to which a method and an apparatus of training a text erasure model and a method and an apparatus of displaying a translation may be applied may include a terminal device, and the terminal device may implement a method and an apparatus of training a text erasure model and a method and an apparatus of displaying a translation provided in embodiments of the present disclosure without interacting with a server.

As shown in FIG. 1, a system architecture 100 according to such embodiments may include terminal devices 101, 102 and 103, a network 104, and a server 105. The network 104 is used as a medium for providing a communication link between the terminal devices 101, 102, 103 and the server 105. The network 104 may include various connection types, such as wired and/or wireless communication links, and the like.

The terminal devices 101, 102 and 103 may be used by a user to interact with the server 105 through the network 104, so as to receive or send messages. The terminal devices 101, 102 and 103 may be installed with various communication client applications, such as knowledge reading applications, web browser applications, search applications, instant messaging tools, mailbox clients and/or social platform software, etc. (for example only).

The terminal devices 101, 102 and 103 may be various electronic devices having display screens and supporting web browsing, including but not limited to smartphones, tablet computers, laptop computers, desktop computers, etc.

The server 105 may be a server that provides various services, such as a background management server (for example only) that provides a support for a content browsed by the user using the terminal devices 101, 102 and 103. The background management server may analyze and process a received user request and other data, and feed back a processing result (e.g., a webpage, an information or data acquired or generated according to the user request) to the terminal devices.

It should be noted that the method of training the text erasure model and the method of displaying the translation provided by embodiments of the present disclosure may generally be performed by the terminal device 101, 102 or 103. Accordingly, the apparatus of training the text erasure model and the apparatus of displaying the translation provided by embodiments of the present disclosure may also be arranged in the terminal device 101, 102 or 103.

Alternatively, the method of training the text erasure model and the method of displaying the translation provided by embodiments of the present disclosure may generally be performed by the server 105. Accordingly, the apparatus of training the text erasure model and the apparatus of displaying the translation provided by embodiments of the present disclosure may be generally arranged in the server 105. The method of training the text erasure model and the method of displaying the translation provided by embodiments of the present disclosure may also be performed by a server or server cluster different from the server 105 and capable of communicating with the terminal devices 101, 102, 103 and/or the server 105. Accordingly, the apparatus of training the text erasure model and the apparatus of displaying the translation provided by embodiments of the present disclosure may also be arranged in a server or server cluster different from the server 105 and capable of communicating with the terminal devices 101, 102, 103 and/or the server 105.

For example, the server 105 may process a training set by using a generator of a generative adversarial network model to obtain a set of simulated text block-erased images, and the generative adversarial network model includes a generator and a discriminator. The generator and the discriminator may be alternately trained by using a set of real text block-erased images and the set of simulated text block-erased images, so as to obtain a trained generator and a trained discriminator. The trained generator may be determined as a text erasure model. Alternatively, the generator and the discriminator may be alternately trained using the set of real text block-erased images and the set of simulated text block-erased images by a server or server cluster capable of communicating with the terminal devices 101, 102, 103 and/or the server 105, so as to obtain the text erasure model, i.e., the trained generator.

It should be understood that the number of terminal devices, network and server shown in FIG. 1 is merely schematic. According to implementation needs, any number of terminal devices, networks and servers may be provided.

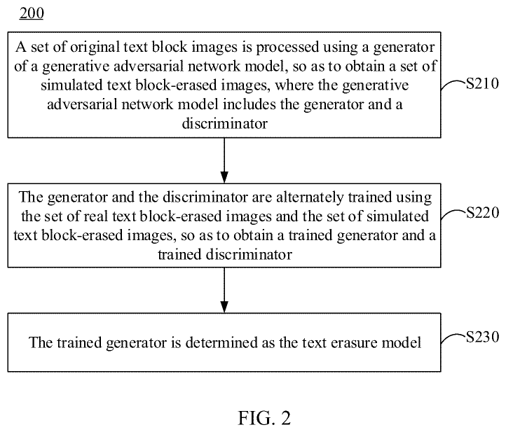

FIG. 2 schematically shows a flowchart of a method of training a text erasure model according to embodiments of the present disclosure.

As shown in FIG. 2, a method 20) includes operation S210 to operation S230.

In operation S210, a set of original text block images is processed using a generator of a generative adversarial network model, so as to obtain a set of simulated text block-erased images, where the generative adversarial network model includes the generator and a discriminator.

In operation S220, the generator and the discriminator are alternately trained using the set of real text block-erased images and the set of simulated text block-erased images, so as to obtain a trained generator and a trained discriminator.

In operation S230, the trained generator is determined as the text erasure model.

According to embodiments of the present disclosure, a pixel value of a text-erased region in a real text block-erased image contained in the set of real text block-erased images is determined according to a pixel value of another region in the real text block-erased image other than the text-erased region.

According to embodiments of the present disclosure, the text block image may contain a text erasure region and another background region other than the text erasure region. A text block erasure may be performed to erase a text of the text erasure region in the input text block image, while retaining a texture color of an original background.

According to embodiments of the present disclosure, the generative adversarial network model may include a deep convolutional generative adversarial network model, an earth mover's distance-based generative adversarial network model, or a conditional generative adversarial network model. The generative adversarial network model may include a generator and a discriminator. The generator and the discriminator may include neural network models. The generator may be used to generate a set of simulated text block-erased images, and a set of real text block-erased images may be learned through continuous training of the generator, so as to generate samples consistent with a data distribution of the set of real text block-erased images from scratch, and to confuse the discriminator as much as possible. The discriminator may be used on the set of real text block-erased images and the set of simulated text block-erased images.

According to embodiments of the present disclosure, the earth mover's distance-based generative adversarial network model may solve problems of training asynchrony, training non-convergence and mode collapse of the generator and the discriminator, so that a model quality of the data generation model may be improved.

According to embodiments of the present disclosure, a training process of the earth mover's distance-based generative adversarial network model may include: presetting a learning rate, batch size (that is, the number of real text block-erased images contained in the set of real text block-erased images), a model parameter range of the neural network model, the maximum number of iterations, and the number of training times per iteration.

According to embodiments of the present disclosure, the generator and the discriminator may be iteratively and alternately trained using the set of real text block-erased images and the set of simulated text block-erased images, so that the generator and the discriminator may achieve their respective optimizations through games therebetween, and finally the discriminator may not accurately distinguish the set of real text block-erased images and the set of simulated text block-erased images, that is, a Nash equilibrium is achieved. In this case, it may be considered that the generator learned the data distribution of the set of real text block-erased images, and the trained generator may be determined as the text erasure model.

According to embodiments of the present disclosure, iteratively and alternately training the generator and the discriminator by using the set of real text block-erased images and the set of simulated text block-erased images may include the following steps. During each iteration, with a model parameter of the generator being kept unchanged, the discriminator is trained using the set of real text block-erased images and the set of simulated text block-erased images until reaching the number of training times set for the discriminator in this iteration. After the number of training times set for the discriminator in this iteration is reached, with a model parameter of the discriminator being kept unchanged, the generator is trained using the set of simulated text block-erased images until reaching the number of training times set for the generator in this iteration. It should be noted that, during an execution of each training process, a set of simulated text block-erased images corresponding to this training process may be generated using the generator. The above-mentioned methods of training the generator and the discriminator are merely exemplary embodiments, and the present disclosure is not limited thereto. The present disclosure may further include training methods known in the art, as long as the training of the generator and the discriminator may be implemented.

According to embodiments of the present disclosure, an appropriate training strategy may be selected according to actual needs, and is not limited herein. For example, the training strategy may include one selected from: in each iteration, the generator is trained one time and the discriminator is trained one time; the generator is trained one time and the discriminator is trained multiple times; the generator is trained multiple times and the discriminator is trained one time; or the generator is trained multiple times and the discriminator is trained multiple times.

According to embodiments of the present disclosure, a set of original text block images is processed using a generator of a generative adversarial network model, so as to obtain a set of simulated text block-erased images. The generator and the discriminator are alternately trained using the set of real text block-erased images and the set of simulated text block-erased images, so as to obtain a trained generator and a trained discriminator. The trained generator is determined as a text erasure model. Since a pixel value of a text-erased region in a real text block-erased image contained in the set of real text block-erased images is determined according to a pixel value of another region, the text erasure model may achieve a color of the text-erased region as consistent as possible with the another region (that is, the background region), so that an erasure effect and the user's visual experience may be improved.

According to embodiments of the present disclosure, the set of original text block images includes a first set of original text block images and a second set of original text block images, and the set of simulated text block-erased images includes a first set of simulated text block-erased images and a second set of simulated text block-erased images. Processing the set of original text block images using the generator of the generative adversarial network model to obtain the set of simulated text block-erased images may include the following operations. The first set of original text block images is processed using the generator to generate the first set of simulated text block-erased images; and the second set of second original text block images is processed using the generator to generate the second set of simulated text block-erased images.

According to embodiments of the present disclosure, generating the set of simulated text block-erased images using the generator may include: inputting the first set of original text block images and first random noise data into the generator to obtain the first set of simulated text block-erased images; and inputting the first set of original text block images and second random noise data into the generator to obtain the second set of simulated text block-erased images. A form of the first random noise data and the second random noise data may include Gaussian noise.

According to embodiments of the present disclosure, the set of real text block-erased images includes a first set of real text block-erased images and a second set of real text block-erased images. Alternately training the generator and the discriminator by using the set of real text block-erased images and the set of simulated text block-erased images to obtain the trained generator and the trained discriminator may include the following operations.

The discriminator is trained using the first set of real text block-erased images and the first set of simulated text block-erased images. The generator is trained using the second set of simulated text block-erased images. An operation of training the discriminator and an operation of training the generator are alternately performed until a convergence condition of the generative adversarial network model is met. A generator and a discriminator obtained when the convergence condition of the generative adversarial network model is met are determined as the trained generator and the trained discriminator.

According to embodiments of the present disclosure, the convergence condition of the generative adversarial network model may include that the generator converges, both the generator and the discriminator converge, or the iteration reaches a termination condition. The iteration reaching the termination condition may include that the number of iterations is equal to the predetermined number of iterations.

According to embodiments of the present disclosure, alternately performing the operation of training the discriminator and the operation of training the generator may be understood as follows. During a t^{th} iteration process, with the model parameter of the generator being kept unchanged, the discriminator is trained using the set of real text block-erased images and the first set of simulated text block-erased images, and the above process is repeatedly performed to reach the number of training times set for the discriminator in this iteration, where t is an integer greater than or equal to 2. During each training process, a first set of simulated text block images corresponding to this training process may be generated using the generator.

According to embodiments of the present disclosure, after the number of training times set for the discriminator in this iteration is reached, with the model parameter of the discriminator being kept unchanged, the generator is trained using the second set of simulated text block-erased images, and the above process is repeatedly performed to reach the number of training times set for the generator in this iteration. During each training process, a second set of simulated text block images corresponding to this training process may be generated using the generator, where 2≤t≤T, T represents the predetermined number of iterations, and t and T are integers.

According to embodiments of the present disclosure, for the t^{th} iteration, the model parameter of the generator that is kept unchanged refers to the model parameter of the generator obtained by a last time of training of the generator for completing a (t−1)^{th} iteration. The model parameter of the discriminator that is kept unchanged refers to the model parameter of the discriminator obtained by a last time of training of the discriminator for completing the t^{th} iteration.

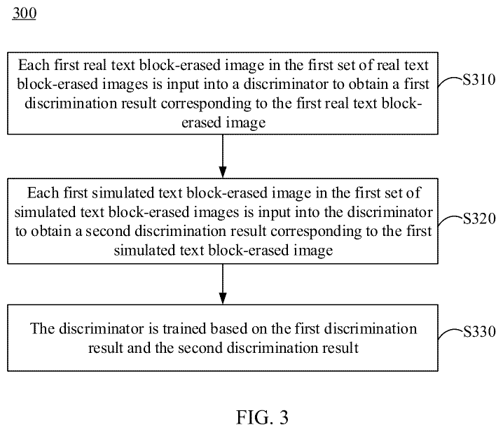

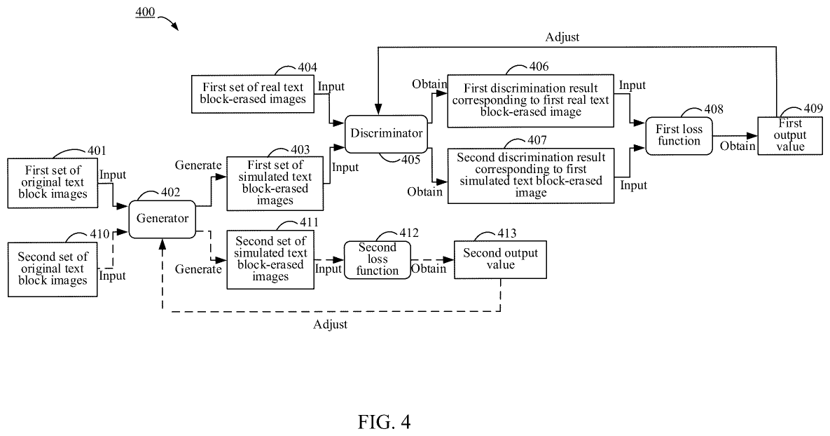

The method of training the text erasure model according to embodiments of the present disclosure will be further described with reference to FIG. 3 to FIG. 4 in conjunction with specific embodiments.

FIG. 3 schematically shows a flowchart of training a discriminator using a first set of real text block-erased images and a first set of simulated text block-erased images according to embodiments of the present disclosure.

According to embodiments of the present disclosure, the first set of real text block-erased images contains a plurality of first real text block-erased images, and the first set of simulated text block-erased images contains a plurality of first simulated text block-erased images.

As shown in FIG. 3, a method 300 includes operation S310 to operation S330.

In operation S310, each first real text block-erased image in the first set of real text block-erased images is input into a discriminator to obtain a first discrimination result corresponding to the first real text block-erased image.

In operation S320, each first simulated text block-erased image in the first set of simulated text block-erased images is input into the discriminator to obtain a second discrimination result corresponding to the first simulated text block-erased image.

In operation S330, the discriminator is trained based on the first discrimination result and the second discrimination result.

According to embodiments of the present disclosure, the discriminator is actually a classifier. After the first real text block-erased image and the first simulated text block-erased image are respectively input into the discriminator, the discriminator is trained according to the first discrimination result corresponding to the first real text block-erased image and the second discrimination result corresponding to the first simulated text block-erased image, so that the discriminator may not accurately determine whether the first real text block-erased image or the first simulated text block-erased image is input, that is, the first discrimination result corresponding to the first real text block-erased image and the second discrimination result corresponding to the first simulated text block-erased image may be as identical as possible.

According to embodiments of the present disclosure, training the discriminator based on the first discrimination result and the second discrimination result may include the following operations.

With the model parameter of the generator being kept unchanged, a first output value is obtained based on a first loss function by using the first discrimination result and the second discrimination result. The model parameter of the discriminator is adjusted according to the first output value to obtain an adjusted model parameter of the discriminator.

According to embodiments of the present disclosure, training the generator using the second set of simulated text block-erased images may include the following operations.

With the adjusted model parameter of the discriminator being kept unchanged a second output value is obtained based on a second loss function by using the second set of simulated text block-erased images. The model parameter of the generator is adjusted according to the second output value.

According to embodiments of the present disclosure, in the t^{th} iteration process, with the model parameter of the generator being kept unchanged, the first discrimination result corresponding to the first real text block-erased image and the second discrimination result corresponding to the first simulated text block-erased image are input into the first loss function to obtain the first output value. The model parameter of the discriminator is adjusted according to the first output value, and the above process is repeatedly performed to reach the number of training times set for the discriminator in this iteration.

According to embodiments of the present disclosure, after the number of training times set for the discriminator in this iteration is reached, with the adjusted model parameter of the discriminator being kept unchanged, each second simulated text block-erased image contained in the second set of simulated text block-erased images is input into the second loss function to obtain the second output value. The model parameter of the generator is adjusted according to the second output value. The above process is repeatedly performed to reach the number of training times set for the generator in this iteration.

According to embodiments of the present disclosure, the first loss function includes a discriminator loss function and a minimum mean square error loss function, and the second loss function includes a generator loss function and the minimum mean square error loss function. The discriminator loss function, the minimum mean square error loss function and the generator loss function are loss functions containing a regularization term.

According to embodiments of the present disclosure, the discriminator loss function, the minimum mean square error loss function and the generator loss function included in the first loss function are loss functions containing a regularization item, and a combination of the above-mentioned loss functions may facilitate de-noising in the training process, so that a text erasure result may be more realistic and reliable.

FIG. 4 schematically shows a schematic diagram of a training process of a text erasure model according to embodiments of the present disclosure.

As shown in FIG. 4, a training process 400 of the text erasure model may include: during each iteration process, with a model parameter of a generator 402 being kept unchanged, a first set of original text block images 401 is input into the generator 402 to obtain a first set of simulated text block-erased images 403.

Each first real text block-erased image in the first set of real text block-erased images 404 is input into a discriminator 405 to obtain a first discrimination result 406 corresponding to the first real text block-erased image. Each first simulated text block-erased image in the first set of simulated text block-erased images 403 is input into the discriminator 405 to obtain a second discrimination result 407 corresponding to the first simulated text block-erased image.

The first discrimination result 406 corresponding to the first real text block-erased image and the second discrimination result 407 corresponding to the first simulated text block-erased image are input into a first loss function 408 to obtain a first output value 409. A model parameter of the discriminator 405 is adjusted according to the first output value 404). The above process is repeatedly performed until the number of training times set for the discriminator 405 in this iteration is reached.

After the number of training times set for the discriminator 405 in this iteration is reached, with the model parameter of the discriminator 405 being kept unchanged, a second set of original text block images 410 is input into the generator 402 to obtain a second set of simulated text block-erased images 411. Each second simulated text block-erased image in the second set of simulated text block-erased images 411 is input into a second loss function 412 to obtain a second output value 413. The model parameter of the generator 402 is adjusted according to the second output value 413. The above process is repeatedly performed until the number of training times set for the generator 402 in this iteration is reached.

The training process for the discriminator 405 and the training process for the generator 402 described above are alternately performed until a convergence condition of the generative adversarial network model is met, and the training is completed.

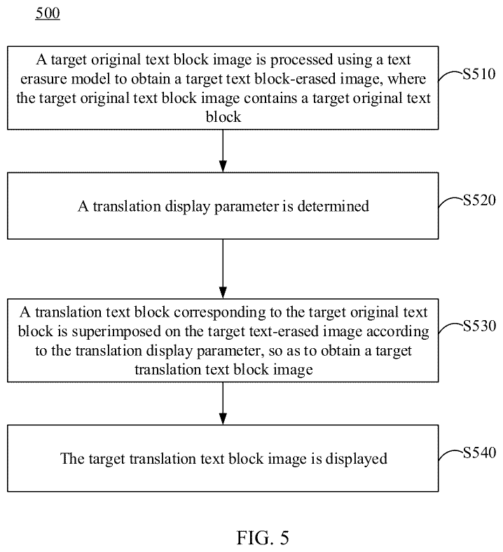

FIG. 5 schematically shows a flowchart of a method of displaying a translation according to embodiments of the present disclosure.

As shown in FIG. 5, a method 500 includes operation S510 to operation S540.

In operation S510, a target original text block image is processed using a text erasure model to obtain a target text block-erased image, where the target original text block image contains a target original text block.

In operation S520, a translation display parameter is determined.

In operation S530, a translation text block corresponding to the target original text block is superimposed on the target text block-erased image according to the translation display parameter, so as to obtain a target translation text block image.

In operation S540, the target translation text block image is displayed.

The text erasure model is trained using the methods described above in operations S210 to S240.

According to embodiments of the present disclosure, the target original text block image may contain a text erasure region and a background region other than the text erasure region, the target text block-erased image may contain an image in which a text in the text erasure region of the target original text block image is erased, and the target original text block may include the text erasure region in the target original text block image.

According to embodiments of the present disclosure, the target text block-erased image is obtained by inputting the target original text block image into the text erasure model. The text erasure model is obtained by: generating a set of simulated text block images using the generator of the generative adversarial network model, alternately training the generator and the discriminator of the generative adversarial network model using the set of real text block-erased images and the set of simulated text block-erased images to obtain a trained generator and a trained discriminator, and determining the trained generator as the text erasure model.

According to embodiments of the present disclosure, the translation display parameter may include: a text arrangement parameter value, a text color and a text position of a translation obtained by translating a text in the text erasure region of the target original text block image.

According to embodiments of the present disclosure, the text arrangement parameter value of the translation may include the number of translation display lines and/or a translation display height, and a translation display direction; the text color of the translation may be determined by a text color in the text erasure region of the target original text block image, the text position of the translation may be consistent with a text position of the text erasure region in the target original text block image.

According to embodiments of the present disclosure, the translation may be superimposed on the target text-erased image corresponding to the position of the text erasure region in the target original text block image, so as to obtain the target translation text block image.

According to embodiments of the present disclosure, the target original text block image is processed using the text erasure model to obtain the target text block-erased image, the translation display parameter is determined, and the translation text block corresponding to the target original text block is superimposed on the target text-erased image to obtain the target translation text block image according to the translation display parameter, and the target translation text block image is displayed. In this way, a translation function for a text in a text block image may be achieved effectively, and a display image of the translation is complete and beautiful, so that the user's visual experience may be improved.

According to embodiments of the present disclosure, if it is determined that a text box corresponding to the target original text block is not a square text box, the text box may be transformed into the square text box using an affine transformation.

According to embodiments of the present disclosure, before processing the target original text block image using the text erasure model, if it is detected based on a paragraph detection model that the text box of the text erasure region in the target original text block image is an irregularly shaped quadrilateral text box, the irregularly shaped quadrilateral text box may be transformed into a square text box using an affine transformation. The quadrilateral text box may be a text box corresponding to the text erasure region of the target original text block image, and the square text box may be a rectangle.

According to embodiments of the present disclosure, after the translation translated from the text in the square text box obtained after transformation is pasted on the target text block-erased image corresponding to the text erasure region in the target original text block image, an inverse transformation may be performed on the square text box by using the affine transformation, so that the square text box is transformed into a quadrilateral text box having same shape and size as the text box corresponding to the text erasure region of the target original text block image.

According to embodiments of the present disclosure, the affine transformation is a linear transformation from two-dimensional coordinates to two-dimensional coordinates, in which “straightness” and “parallelism” of a two-dimensional graphic may be maintained. The straightness may refer to that after transformation, a straight line is still a straight line without bending, and an arc is still an arc; the parallelism may refer to that a relative positional relationship between two-dimensional graphics remains unchanged, parallel lines are still parallel lines, and an intersection angle of intersecting straight lines remains unchanged.

According to embodiments of the present disclosure, the affine transformation may be implemented through translation, scaling, flipping, rotation, clipping and so on.

According to embodiments of the present disclosure, for example, the text box corresponding to the text erasure region of the target original text block image is an irregularly shaped quadrilateral box, and the irregularly shaped quadrilateral box corresponds to a text content in an oblique text erasure region. Then, a position information of each corner of the irregularly shaped quadrilateral box indicates different two-dimensional coordinates, and the text box corresponding to the text erasure region of the target original text block image may be corrected into two-dimensional coordinates of a quadrilateral box having a rectangular shape through the affine transformation.

According to embodiments of the present disclosure, the target original text block image may include a plurality of target original text block sub-images.

According to embodiments of the present disclosure, the target original text block image may be obtained by stitching the plurality of target original text block sub-images, and the stitched target original text block image may be input into the text erasure model for erasure.

According to embodiments of the present disclosure, for example, the plurality of target original text block sub-images may be normalized to a fixed height, and the plurality of target original text block sub-images may be combined and stitched into one or more regularly arranged large images as the target original text block image.

According to embodiments of the present disclosure, the plurality of target original text block sub-images are stitched to obtain the target original text block image, and the target original text block image is input into the text erasure model for erasure, so that the number of images required to pass through the text erasure model is greatly reduced, and an efficiency of the text erasure is improved.

According to embodiments of the present disclosure, the translation display parameter may include a translation pixel value.

According to embodiments of the present disclosure, determining the translation display parameter may include the following operations.

A text region of the target original text block image is determined. A pixel mean value of the text region of the target original text block image is determined. The pixel mean value of the text region of the target original text block image is determined as the translation pixel value.

According to embodiments of the present disclosure, determining the text region of the target original text block image may include the following operations.

The target original text block image is processed using an image binarization to obtain a first image region and a second image region. A first pixel mean value of the target original text block image corresponding to the first image region is determined. A second pixel mean value of the target original text block image corresponding to the second image region is determined. A third pixel mean value corresponding to the target text block-erased image is determined. The text region of the target original text block image is determined according to the first pixel mean value, the second pixel mean value and the third pixel mean value.

According to embodiments of the present disclosure, the image binarization may refer to setting a threshold T, and dividing, using the threshold T, data of the image into two parts, including a pixel group with a pixel value greater than T and a pixel group with a pixel value less than T, so that the entire image presents an obvious visual effect of only black and white.

According to embodiments of the present disclosure, the first image region may be the text erasure region of the target original text block image, or may be other regions of the target original text block image except the text erasure region. The second image region may be the text erasure region of the target original text block image, or may be other regions of the target original text block image except the text erasure region.

According to embodiments of the present disclosure, for example, the first pixel mean value of the target original text block image corresponding to the first image region may be represented by A1, the second pixel mean value of the target original text block image corresponding to the second image region may be represented by A2, and the third pixel mean value corresponding to the target text block-erased image may be represented by A3.

According to embodiments of the present disclosure, the third pixel mean value corresponding to the target text block-erased image may be determined according to a pixel value of another region in the target text block-erased image other than the text erasure region.

According to embodiments of the present disclosure, determining the text region of the target original text block image according to the first pixel mean value, the second pixel mean value and the third pixel mean value may include the following operations.

If it is determined that an absolute value of a difference between the first pixel mean value and the third pixel mean value is less than an absolute value of a difference between the second pixel mean value and the third pixel mean value, the first image region corresponding to the first pixel mean value is determined as the text region of the target original text block image, if it is determined that the absolute value of the difference between the first pixel mean value and the third pixel mean value is greater than or equal to the absolute value of the difference between the second pixel mean value and the third pixel mean value, the second image region corresponding to the second pixel mean value is determined as the text region of the target original text block image.

According to embodiments of the present disclosure, a determination is performed on the first pixel mean value A1 of the target original text block image corresponding to the first image region and the second pixel mean value A2 of the target original text block image corresponding to the second image region, based on the third pixel mean value A3 corresponding to the target text block-erased image, so as to determine the text region of the target original text block image.

According to embodiments of the present disclosure, for example, if |A1−A3|<|A2−A3|, the first image region corresponding to A1 is determined as the text region of the target original text block image, and the second image region corresponding to A2 is determined as another region of the target original text block image other than the text region.

According to embodiments of the present disclosure, if |A1−A3|≥|A2−A3|, the second image region corresponding to A2 is determined as the text region of the target original text block image, and the first image region corresponding to A 1 is determined as another region of the target original text block image other than the text region.

According to embodiments of the present disclosure, the translation display parameter may include a translation arrangement parameter value, which may include a number of translation display lines, a translation display height, or the number of translation display lines and the translation display height.

According to embodiments of the present disclosure, determining the display parameter may include the following operations. The number of translation display lines and/or the translation display height are/is determined according to a height and a width of the text region corresponding to the target text block-erased image, and a height and a width corresponding to the target translation text block.

According to embodiments of the present disclosure, the translation display height may be determined by the height of the text region corresponding to the target text block-erased image.

According to embodiments of the present disclosure, a text width of the translation may refer to a text width when the translation is arranged in one line. The text width of the translation when the translation is arranged in one line may be obtained according to a ratio of a font width to a font height of the translation.

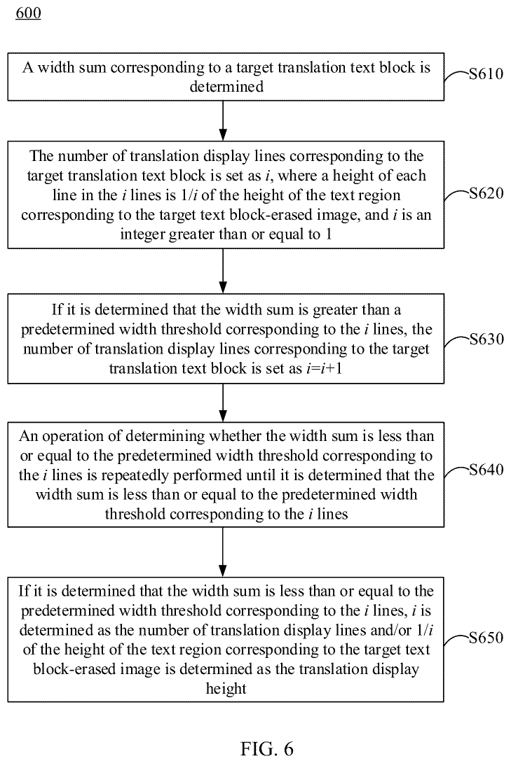

FIG. 6 schematically shows a flowchart of determining a number of translation display lines and/or a translation display height according to embodiments of the present disclosure.

As shown in FIG. 6, determining the number of translation display lines and/or the translation display height according to the height and the width of the text region corresponding to the target text block-erased image and the height and the width corresponding to the target translation text block may include operation S610 to operation S650.

In operation S610, a width sum corresponding to a target translation text block is determined.

In operation S620, the number of translation display lines corresponding to the target translation text block is set as i, where a height of each line in the i lines is 1/i of the height of the text region corresponding to the target text block-erased image, and i is an integer greater than or equal to 1.

In operation S630, if it is determined that the width sum is greater than a predetermined width threshold corresponding to the i lines, the number of translation display lines corresponding to the target translation text block is set as i=i'1, where the predetermined width threshold is determined according to i times of a width of the text region corresponding to the target text block-erased image.

In operation S640, an operation of determining whether the width sum is less than or equal to the predetermined width threshold corresponding to the i lines is repeatedly performed until it is determined that the width sum is less than or equal to the predetermined width threshold corresponding to the I lines.

In operation S650, if it is determined that the width sum is less than or equal to the predetermined width threshold corresponding to the i lines, i is determined as the number of translation display lines and/or 1/i of the height of the text region corresponding to the target text block-erased image is determined as the translation display height.

According to embodiments of the present disclosure, the text width of the translation when the translation is arranged in one line, that is, a text width sum W₁ corresponding to the target translation text block, may be obtained according to the ratio of the font width to the font height of the translation.

According to embodiments of the present disclosure, the number of translation display lines is set to i, and the predetermined width threshold W corresponding to the i lines is determined according to i times of the width of the text region corresponding to the target text block-erased image.

According to embodiments of the present disclosure, the number of translation display lines and/or the translation display height are/is determined by comparing the width sum Wᵢ corresponding to the target translation text block and the predetermined width threshold W corresponding to the i lines.

According to embodiments of the present disclosure, for example, the text in the text region of the target original text block image is “it's cloudy and rainy”. The target translation “ [symbol] is obtained by translating “It's cloudy and rainy”. The text width corresponding to the target translation text block is a text width sum when the target translation block “ [symbol] ” is arranged in one line, which may be represent by W₁.

According to embodiments of the present disclosure, the width of the text region corresponding to the target text block-erased image is W₂, and the predetermined width threshold corresponding to the number i of translation display lines is W, then W=i×W₂.

According to embodiments of the present disclosure, if the number of translation display lines corresponding to the translation text “ [symbol] ” is (i=1), and the text width sum W₁ of the translation is greater than the predetermined width threshold W=1×W₂ corresponding to the number of translation display lines being a, then it means that it is not appropriate to arrange the translation corresponding to the target translation text block in one line, and the number of translation display lines needs to be set as 2. At this time, the number of translation display lines is 2.

According to embodiments of the present disclosure, the above operation is continued, and the text width sum W₁ of the translation is greater than the predetermined W=1×W₂ corresponding to the number of translation display lines being 2, then it means that it is not appropriate to arrange the translation corresponding to the target translation text block in two lines, and the number of translation display lines needs to be set as 3. At this time, the number of translation display lines is 3.

According to embodiments of the present disclosure, the above operation is repeatedly performed until it is determined that the text width sum W₁ of the translation is less than or equal to the predetermined width threshold W=i×W₂ corresponding to the i lines, then i is determined as the number of translation display lines, and 1/i of the height of the text region corresponding to the target text block-erased image is determined as the translation display height.

According to embodiments of the present disclosure, for example, if the text width sum W₁ of the translation is less than or equal to the predetermined width threshold W=3×W₂ corresponding to the number of translation display lines being 3, it means that it is appropriate to arrange the translation corresponding to the target translation text block in three lines, then the number of translation display lines is 3, and the translation display height is ⅓ of the height of the text region corresponding to the target text block-erased image.

According to embodiments of the present disclosure, the translation arrangement parameter value may include a translation display direction. The translation display direction may be determined according to a text direction of the target original text block.

According to embodiments of the present disclosure, the text box of the text region of the target original text block is an irregularly shaped quadrilateral text box, and the irregularly shaped quadrilateral text box may be transformed into a rectangular text box by using an affine transformation, so as to facilitate text erasure and translation pasting. The text box after the translation pasting may be transformed into a text box of a text region with a same shape as the irregularly shaped quadrilateral text box of the text region of the target original text block by using the affine transformation, so as to forming the translation display direction.

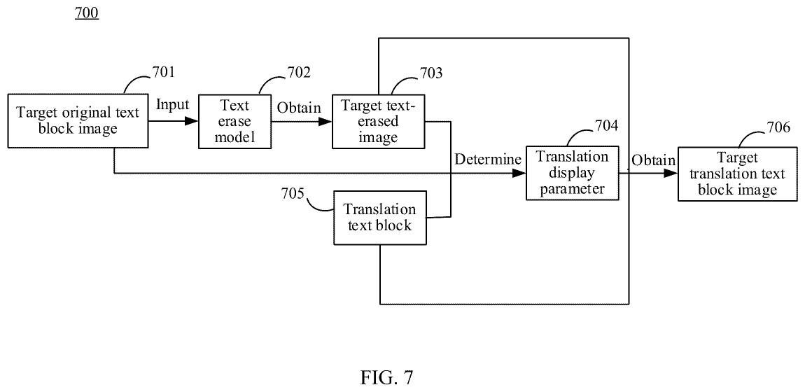

FIG. 7 schematically shows a schematic diagram of a translation display process according to embodiments of the present disclosure.

As shown in FIG. 7, a target original text block image 701 is input into a text erasure model 702 for a text erasure, so as to obtain a target text block-erased image 703. A translation display parameter 704 is determined. A translation text block 705 corresponding to a text region of a target original text block in the target original text block image 701 is superimposed on the target text block-erased image 703 according to the translation display parameter 704, so as to obtain a target translation text block image 706, and the target translation text block image 706 is displayed.

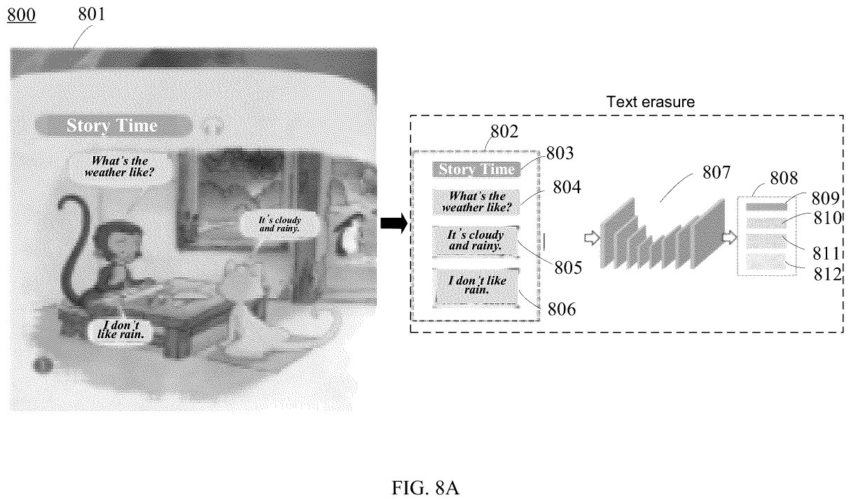

FIG. 8A schematically shows a schematic diagram of a text erasure process 800 according to embodiments of the present disclosure.

FIG. KB schematically shows a schematic diagram of a translation pasting process 8B according to embodiments of the present disclosure.

As shown in FIG. 8A, original text block images 803, 804, 805 and 806 in a set of original text block images 802 detected from an original image 801 are input into a text erasure model 807, text regions of the original text block images 803, 804, 805 and 806 in the set of original text block images 802 are erased, and text block-erased images 809, 810, 811 and 812 in a set of text block-erased images 808 after the text erasure are output.

The translation pasting process 800′ is performed after the text erasure process 800. As shown in FIG. 8B, each original text block image in the set of original text block images is translated, for example, the text region of the original text block image 805 is translated to obtain a translation text block 813 corresponding to the text region of the original text block image 805.

A translation display parameter 814 of the translation text block 813 is determined. The translation display parameter 814 includes: a translation text position, a translation text arrangement parameter value, and a translation pixel value.

The translation text block 813 is superimposed on the text block-erased image 811 in the set of text block-erased images 808 according to the translation display parameter 814, so as to obtain a translation text block image 815.

The above operations are repeatedly performed, so that the text erasure is performed on each original text block image in the set of original text block images 802 and the text pasting is performed, and finally a translation image 816 with a translation display is obtained.

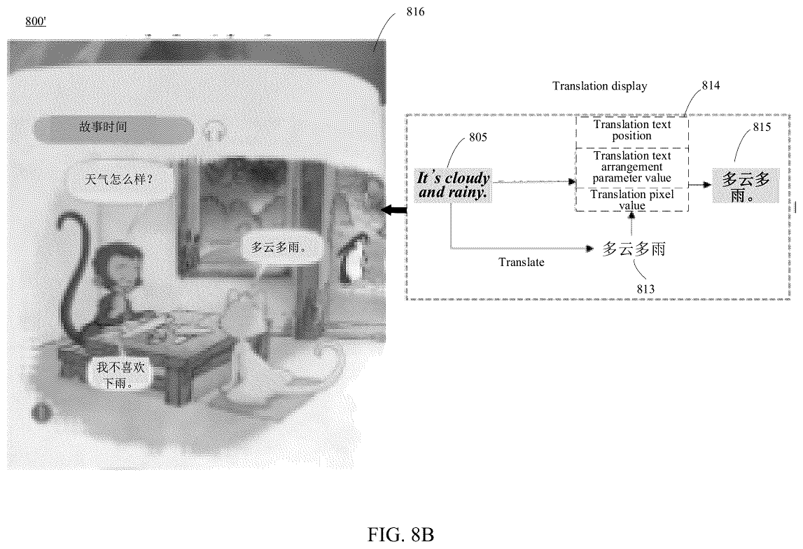

FIG. 9 schematically shows a block diagram of an apparatus of training a text erasure model according to embodiments of the present disclosure.

As shown in FIG. 9, an apparatus 900 of training a text erasure model may include a first obtaining module 910, a second obtaining module 920, and a first determination module 930.

The first obtaining module 910 may be used to process a set of original text block images by using a generator of a generative adversarial network model, so as to obtain a set of simulated text block-erased images. The generative adversarial network model includes the generator and a discriminator.

The second obtaining module 920 may be used to alternately train the generator and the discriminator by using a set of real text block-erased images and the set of simulated text block-erased images, so as to obtain a trained generator and a trained discriminator.

The first determination module 930 may be used to determine the trained generator as the text erasure model.

According to embodiments of the present disclosure, a pixel value of a text-erased region in a real text block-erased image contained in the set of real text block-erased images is determined based on a pixel value of another region in the real text block-erased image other than the text-erased region.

According to embodiments of the present disclosure, the set of original text block images includes a first set of original text block images and a second set of original text block images, and the set of simulated text block-erased images includes a first set of simulated text block-erased images and a second set of simulated text block-erased images.

The first obtaining module 910 may include a first generation sub-module and a second generation sub-module.

The first generation sub-module may be used to process the first set of original text block images by using the generator, so as to generate the first set of simulated text block-erased images.

The second generation sub-module may be used to process the second set of second original text block images by using the generator, so as to generate the second set of simulated text block-erased images.

According to embodiments of the present disclosure, the set of real text block-erased images includes a first set of real text block-erased images and a second set of real text block-erased images. The second obtaining module 920 may include a first training sub-module, a second training sub-module, an execution sub-module, and an obtaining sub-module.

The first training sub-module may be used to train the discriminator by using the first set of real text block-erased images and the first set of simulated text block-erased images.

The second training sub-module may be used to train the generator by using the second set of simulated text block-erased images.

The execution sub-module may be used to alternately perform an operation of training the discriminator and an operation of training the generator until a convergence condition of the generative adversarial network model is met.

The obtaining sub-module may be used to determine a generator and a discriminator obtained in response to the convergence condition of the generative adversarial network model being met as the trained generator and the trained discriminator.

According to embodiments of the present disclosure, the first set of real text block-erased images includes a plurality of first real text block-erased images, and the first set of simulated text block-erased images includes a plurality of first simulated text block-erased images.

The first training sub-module may include a first obtaining unit, a second obtaining unit, and a training unit.

The first obtaining unit may be used to input each first real text block-erased image in the first set of real text block-erased images into the discriminator to obtain a first discrimination result corresponding to the first real text block-erased image.

The second obtaining unit may be used to input each first simulated text block-erased image in the first set of simulated text block-erased images into the discriminator to obtain a second discrimination result corresponding to the first simulated text block-erased image.

The training unit may be used to train the discriminator based on the first discrimination result and the second discrimination result.

According to embodiments of the present disclosure, the first training sub-module may further include a third obtaining unit and a first adjustment unit.

The third obtaining unit may be used to obtain, with a model parameter of the generator being kept unchanged, a first output value based on a first loss function by using the first discrimination result and the second discrimination result.

The first adjustment unit may be used to adjust a model parameter of the discriminator according to the first output value, so as to obtain an adjusted model parameter of the discriminator.

The second training sub-module may include a fourth obtaining unit and a second adjustment unit.

The fourth obtaining unit may be used to obtain, with the adjusted model parameter of the discriminator being kept unchanged, a second output value based on a second loss function by using the second set of simulated text block-erased images.

The second adjustment unit may be used to adjust the model parameter of the generator according to the second output value.

According to embodiments of the present disclosure, the first loss function includes a discriminator loss function and a minimum mean square error loss function, the second loss function includes a generator loss function and the minimum mean square error loss function, and the discriminator loss function, the minimum mean square error loss function and the generator loss function are loss functions containing a regularisation term.

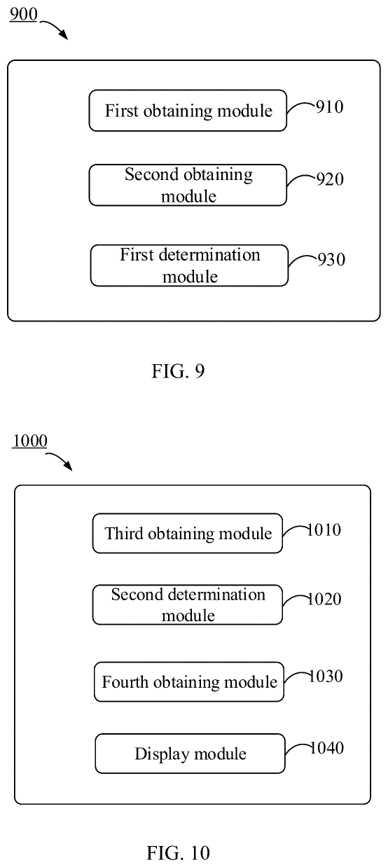

FIG. 10 schematically shows a block diagram of an apparatus of displaying a translation according to embodiments of the present disclosure.

As shown in FIG. 10, an apparatus 1000 of displaying a translation may include a third obtaining module 1010, a second determination module 1020, a fourth obtaining module 1030, and a display module 1040.

The third obtaining module 1010 may be used to process a target original text block image by using a text erasure model, so as to obtain a target text block-erased image. The target original text block image contains a target original text block.

The second determination module 1020 may be used to determine a translation display parameter.

The fourth obtaining module 1030 may be used to superimpose a translation text block corresponding to the target original text block on the target text-erased image according to the translation display parameter, so as to obtain a target translation text block image.

The display module 1040 may be used to display the target translation text block image.

The text erasure model is trained using the method of training the text erasure model described above.

According to embodiments of the present disclosure, the apparatus 1000 of displaying the translation may further include a transformation module.

The transformation module may be used to transform, by using an affine transformation, a text box corresponding to the target original text block into a square text box, in response to the text box being not the square text box.

According to embodiments of the present disclosure, the target original text block image includes a plurality of target original text block sub-images.

The apparatus 1000 of displaying the translation may further include a stitching module.

The stitching module may be used to stitch the plurality of target original text block sub-images to obtain the target original text block image.

According to embodiments of the present disclosure, the translation display parameter includes a translation pixel value.

The second determination module 1020 may include a first determination sub-module, a second determination sub-module, and a third determination sub-module.

The first determination sub-module may be used to determine a text region of the target original text block image.

The second determination sub-module may be used to determine a pixel mean value of the text region of the target original text block image.

The third determination sub-module may be used to determine the pixel mean value of the text region of the target original text block image as the translation pixel value.

According to embodiments of the present disclosure, the first determination sub-module may include a fifth obtaining unit, a first determination unit, a second determination unit, a third determination unit, and a fourth determination unit.

The fifth obtaining unit may be used to process the target original text block image by using an image binarization, so as to obtain a first image region and a second image region.

The first determination unit may be used to determine a first pixel mean value of the target original text block image corresponding to the first image region.

The second determination unit may be used to determine a second pixel mean value of the target original text block image corresponding to the second image region.

The third determination unit may be used to determine a third pixel mean value corresponding to the target text block-erased image.

The fourth determination unit may be used to determine the text region of the target original text block image according to the first pixel mean value, the second pixel mean value and the third pixel mean value.

According to embodiments of the present disclosure, the fourth determination unit may include a first determination sub-unit and a second determination sub-unit.

The first determination sub-unit may be used to determine the first image region corresponding to the first pixel mean value as the text region of the target original text block image, in response to a determination that an absolute value of a difference between the first pixel mean value and the third pixel mean value is less than an absolute value of a difference between the second pixel mean value and the third pixel mean value.

The second determination sub-unit may be used to determine the second image region corresponding to the second pixel mean value as the text region of the target original text block image, in response to a determination that the absolute value of the difference between the first pixel mean value and the third pixel mean value is greater than or equal to the absolute value of the difference between the second pixel mean value and the third pixel mean value.

According to embodiments of the present disclosure, the translation display parameter includes a translation arrangement parameter value, and the translation arrangement parameter value includes a number of translation display lines and/or a translation display height.

The second determination module 1020 may further include a fourth determination sub-module.

The fourth determination sub-module may be used to determine the number of translation display lines and/or the translation display height according to a height of a text region corresponding to the target text block-erased image, a width of the text region corresponding to the target text block-erased image, a height corresponding to the target translation text block, and a width corresponding to the target translation text block.

According to embodiments of the present disclosure, the fourth determination sub-module may include a fifth determination unit, a sixth determination unit, a setting unit, a repeating unit, and a seventh determination unit.

The fifth determination unit may be used to determine a width sum corresponding to the target translation text block.

The sixth determination unit may be used to set the number of translation display lines corresponding to the target translation text block as I, where a height of each line in i lines is Ill of the height of the text region corresponding to the target text block-erased image, and i is an integer greater than or equal to 1.

The setting unit may be used to set, in response to a determination that the width sum is greater than a predetermined width threshold corresponding to the i lines, the number of translation display lines corresponding to the target translation text block as i=i+1. The predetermined width threshold is determined according to i times of the width of the text region corresponding to the target text block-erased image.

The repeating unit may be used to repeatedly perform an operation of determining whether the width sum is less than or equal to the predetermined width threshold corresponding to the i lines, until it is determined that the width sum is less than or equal to the predetermined width threshold corresponding to the i lines.

The seventh determination unit may be used to determine i as the number of translation display lines and/or determining 1/i of the height of the text region corresponding to the target text block-erased image as the translation display height, in response to a determination that the width sum is less than or equal to the predetermined width threshold corresponding to the i lines.

According to embodiments of the present disclosure, the translation arrangement parameter value includes a translation display direction, and the translation display direction is determined according to a text direction of the target original text block.

According to embodiments of the present disclosure, the present disclosure further provides an electronic device, a readable storage medium, and a computer program product.

According to embodiments of the present disclosure, an electronic device is provided, including: at least one processor; and a memory communicatively connected to the at least one processor. The memory stores instructions executable by the at least one processor, and the instructions, when executed by the at least one processor, cause the at least one processor to implement the methods as described above.

According to embodiments of the present disclosure, a non-transitory computer-readable storage medium having computer instructions therein is provided, and the computer instructions are used to cause a computer to implement the methods as described above.

According to embodiments of the present disclosure, a computer program product containing a computer program is provided, and the computer program, when executed by a processor, causes the processor to implement the methods as described above.

In technical solutions of the present disclosure, a collection, a storage, a use, a processing, a transmission, a provision, a disclosure and other processing of user personal information involved comply with provisions of relevant laws and regulations, take necessary security measures, and do not violate public order and good custom.

In the technical solutions of the present disclosure, the acquisition or collection of user personal information has been authorized or allowed by users.

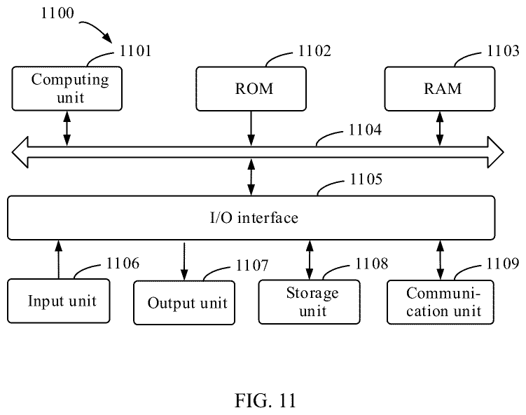

FIG. 11 schematically shows a block diagram of an electronic device suitable for implementing the method of training the text erasure model or the method of displaying the translation text according to embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 11, the electronic device 1100 includes a computing unit 1101 which may perform various appropriate actions and processes according to a computer program stored in a read only memory (ROM) 1102 or a computer program loaded from a storage unit 1108 into a random access memory (RAM) 1103. In the RAM 1103, various programs and data necessary for an operation of the electronic device 1100 may also be stored. The computing unit 1101, the ROM 1102 and the RAM 1103 are connected to each other through a bus 1104. An input/output (I/O) interface 1105 is also connected to the bus 1104.

A plurality of components in the electronic device 1100 are connected to the I/O interface 1105, including: an input unit 1106, such as a keyboard, or a mouse: an output unit 1107, such as displays or speakers of various types; a storage unit 1108, such as a disk, or an optical disc; and a communication unit 1109, such as a network card, a modem, or a wireless communication transceiver. The communication unit 1109 allows the electronic device 1100 to exchange information/data with other devices through a computer network such as Internet and/or various telecommunication networks.

The computing unit 1101 may be various general-purpose and/or dedicated processing assemblies having processing and computing capabilities. Some examples of the computing units 1101 include, but are not limited to, a central processing unit (CPU), a graphics processing unit (GPU), various dedicated artificial intelligence (A1) computing chips, various computing units that run machine learning model algorithms, a digital signal processing processor (DSP), and any suitable processor, controller, microcontroller, etc. The computing unit 1101 executes various methods and processes described above, such as the method of training the text erasure model or the method of displaying the translation text. For example, in some embodiments, the method of training the text erasure model or the method of displaying the translation text may be implemented as a computer software program which is tangibly embodied in a machine-readable medium, such as the storage unit 1108, in some embodiments, the computer program may be partially or entirely loaded and/or installed in the electronic device 1100 via the ROM 1102 and/or the communication unit 1109. The computer program, when loaded in the RAM 1103 and executed by the computing unit 1101, may execute one or more steps in the method of training the text erasure model or the method of displaying the translation text described above. Alternatively, in other embodiments, the computing unit 1101 may be used to perform the method of training the text erasure model or the method of displaying the translation text by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode my tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be mode according to design requirements and other factors. Any modifications, equivalent replacements and improvements made within the spirit and principles of the present disclosure shall be contained in the scope of protection of the present disclosure.

1. A method of training a text erasure model, comprising:
processing a set of original text block images by using a generator of a generative adversarial network model, so as to obtain a set of simulated text block-erased images, wherein the generative adversarial network model comprises the generator and a discriminator;
alternately training the generator and the discriminator by using a set of real text block-erased images and the set of simulated text block-erased images, so as to obtain a trained generator and a trained discriminator; and
determining the trained generator as the text erasure model,
wherein a pixel value of a text-erased region in a real text block-erased image contained in the set of real text block-erased images is determined based on a pixel value of another region in the real text block-erased image other than the text-erased region.

2. The method according to claim 1, wherein the set of original text block images comprises a first set of original text block images and a second set of original text block images, and the set of simulated text block-erased images comprises a first set of simulated text block-erased images and a second set of simulated text block-erased images, and
wherein the processing a set of original text block images by using a generator of a generative adversarial network model so as to obtain a set of simulated text block-erased images comprises:
processing the first set of original text block images by using the generator, so as to generate the first set of simulated text block-erased images; and
processing the second set of second original text block images by using the generator, so as to generate the second set of simulated text block-erased images.

3. The method according to claim 2, wherein the set of real text block-erased images comprises a first set of real text block-erased images and a second set of real text block-erased images, and
wherein the alternately training the generator and the discriminator by using a set of real text block-erased images and the set of simulated text block-erased images so as to obtain a trained generator and a trained discriminator comprises:
training the discriminator by using the first set of real text block-erased images and the first set of simulated text block-erased images;
training the generator by using the second set of simulated text block-erased images;
alternately performing an operation of training the discriminator and an operation of training the generator until a convergence condition of the generative adversarial network model is met; and
determining a generator and a discriminator obtained in response to the convergence condition of the generative adversarial network model being met as the trained generator and the trained discriminator.

4. The method according to claim 3, wherein the first set of real text block-erased images comprises a plurality of first real text block-erased images, and the first set of simulated text block-erased images comprises a plurality of first simulated text block-erased images, and
wherein the training the discriminator by using the first set of real text block-erased images and the first set of simulated text block-erased images comprises:
inputting each first real text block-erased image in the first set of real text block-erased images into the discriminator to obtain a first discrimination result corresponding to the first real text block-erased image;
inputting each first simulated text block-erased image in the first set of simulated text block-erased images into the discriminator to obtain a second discrimination result corresponding to the first simulated text block-erased image; and
training the discriminator based on the first discrimination result and the second discrimination result.

5. The method according to claim 4, wherein the training the discriminator based on the first discrimination result and the second discrimination result comprises:
obtaining a first output value based on a first loss function by using the first discrimination result and the second discrimination result, with a model parameter of the generator being kept unchanged; and
adjusting a model parameter of the discriminator according to the first output value, so as to obtain an adjusted model parameter of the discriminator, and
wherein the training the generator by using the second set of simulated text block-erased images comprises:
obtaining a second output value based on a second loss function by using the second set of simulated text block-erased images, with the adjusted model parameter of the discriminator being kept unchanged; and
adjusting the model parameter of the generator according to the second output value.

6. The method according to claim 5, wherein the first loss function comprises a discriminator loss function and a minimum mean square error loss function, the second loss function comprises a generator loss function and the minimum mean square error loss function, and the discriminator loss function, the minimum mean square error loss function and the generator loss function are loss functions containing a regularization term.

7. A method of displaying a translation, comprising:
processing a target original text block image by using a text erasure model to obtain a target text block-erased image, wherein the target original text block image comprises a target original text block;
determining a translation display parameter;
superimposing a translation text block corresponding to the target original text block on the target text block-erased image according to the translation display parameter, so as to obtain a target translation text block image; and
displaying the target translation text block image,
wherein the text erasure model is trained using the method according to claim 1.

8. The method according to claim 7, further comprising:
in response to a text box corresponding to the target original text block being not a square text box,
transforming the text box into the square text box by using an affine transformation.

9. The method according to claim 7, wherein the target original text block image comprises a plurality of target original text block sub-images,
the method further comprising:
stitching the plurality of target original text block sub-images to obtain the target original text block image.

10. The method according to claim 7,
wherein the translation display parameter comprises a translation pixel value, and
wherein the determining a translation display parameter comprises:
determining a text region of the target original text block image;
determining a pixel mean value of the text region of the target original text block image; and
determining the pixel mean value of the text region of the target original text block image as the translation pixel value.

11. The method according to claim 10, wherein the determining a text region of the target original text block image comprises:
processing the target original text block image by using an image binarization, so as to obtain a first image region and a second image region;
determining a first pixel mean value of the target original text block image corresponding to the first image region;
determining a second pixel mean value of the target original text block image corresponding to the second image region;
determining a third pixel mean value corresponding to the target text block-erased image; and
determining the text region of the target original text block image according to the first pixel mean value, the second pixel mean value and the third pixel mean value.

12. The method according to claim 11, wherein the determining the text region of the target original text block image according to the first pixel mean value, the second pixel mean value and the third pixel mean value comprises:
determining the first image region corresponding to the first pixel mean value as the text region of the target original text block image, in response to a determination that an absolute value of a difference between the first pixel mean value and the third pixel mean value is less than an absolute value of a difference between the second pixel mean value and the third pixel mean value; and
determining the second image region corresponding to the second pixel mean value as the text region of the target original text block image, in response to a determination that the absolute value of the difference between the first pixel mean value and the third pixel mean value is greater than or equal to the absolute value of the difference between the second pixel mean value and the third pixel mean value.

13. The method according to claim 7,
wherein the translation display parameter comprises a translation arrangement parameter value, and the translation arrangement parameter value comprises a number of translation display lines and/or a translation display height, and
wherein the determining a translation display parameter comprises:
determining the number of translation display lines and/or the translation display height, according to a height of a text region corresponding to the target text block-erased image, a width of the text region corresponding to the target text block-erased image, a height corresponding to the target translation text block, and a width corresponding to the target translation text block.

14. The method according to claim 13, wherein the determining the number of translation display lines and/or the translation display height according to a height of a text region corresponding to the target text block-erased image, a width of the text region corresponding to the target text block-erased image, a height corresponding to the target translation text block, and a width corresponding to the target translation text block comprises:
determining a width sum corresponding to the target translation text block;
setting the number of translation display lines corresponding to the target translation text block as i, wherein a height of each line in i lines is 1/i of the height of the text region corresponding to the target text block-erased image, and i is an integer greater than or equal to 1;
setting, in response to a determination that the width sum is greater than a predetermined width threshold corresponding to the i lines, the number of translation display lines corresponding to the target translation text block as i=i+1, wherein the predetermined width threshold is determined according to i times of the width of the text region corresponding to the target text block-erased image;
repeatedly performing an operation of determining whether the width sum is less than or equal to the predetermined width threshold corresponding to the i lines, until it is determined that the width sum is less than or equal to the predetermined width threshold corresponding to the i lines; and
determining i as the number of translation display lines and/or determining 1/i of the height of the text region corresponding to the target text block-erased image as the translation display height, in response to a determination that the width sum is less than or equal to the predetermined width threshold corresponding to the i lines.

15. The method according to claim 7, wherein the translation arrangement parameter value comprises a translation display direction, and the translation display direction is determined according to a text direction of the target original text block.

16-17. (canceled)

18. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 1.

19. A non-transitory computer-readable storage medium having computer instructions therein, wherein the computer instructions are configured to cause a computer to implement the method of claim 1.

20. (canceled)

21. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 7.

22. A non-transitory computer-readable storage medium having computer instructions therein, wherein the computer instructions are configured to cause a computer to implement the method of claim 7.

23. The electronic device according to claim 18, wherein the set of original text block images comprises a first set of original text block images and a second set of original text block images, and the set of simulated text block-erased images comprises a first set of simulated text block-erased images and a second set of simulated text block-erased images, and
wherein the instructions are further configured to cause the at least one processor to at least:
process the first set of original text block images by using the generator, so as to generate the first set of simulated text block-erased images; and
process the second set of second original text block images by using the generator, so as to generate the second set of simulated text block-erased images.
